(19) United States
(12) Patent Application Publication
(10) Pub. No.: US 2004/0262798 A1
(43) Pub. Date: Dec. 30, 2004

(54) Method of foam moulding a synthetic resin article

(76) Inventors: Kazuhiko Hori, Yokohama-shi (JP); Takao Ishibashi, Yokohama-shi (JP); Takahisa Murata, Yokohama-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/493,099

(22) PCT Filed: Feb. 21, 2002
(86) PCT No.: PCT/JP02/01559

(30) Foreign Application Priority Data
Oct. 22, 2001 (JP) 2001-323638

(51) Int. Cl. B29C 44/60

(52) U.S. Cl. 264/40.1; 264/50; 264/102

(57) ABSTRACT

A method of producing a foamed synthetic resin molding article by using a mold comprising a closed space formed by a lower mold and an upper mold as a cavity to be supplied with a material, closing the upper and lower molds, foaming the material, curing the foamed body and demolding the foamed and molded body, wherein the method comprises the steps of supplying the material for foamed synthetic resin molding article under atmospheric pressure, closing the upper and lower molds so that a gas in the mold can be exhausted, causing foam molding, preliminarily measuring a cavity fill-up time required for the foamed body of the material to fill up the cavity, thereafter supplying the material into the cavity under atmospheric pressure, closing the upper and lower molds so that the gas in the mold can be exhausted, causing foaming to proceed, and perfectly closing the upper and lower molds when the cavity fill-up time has passed.

### TECHNICAL FIELD

The present invention relates to a method of producing a foamed synthetic resin molding article by which molding of a foamed synthetic resin molding article having an open cell structure such as flexible polyurethane foam or a closed cell structure can be achieved while suppressing generation of flash and void, adhesion of material after molding is reduced, and cleaning of the mold can be easily conducted.

### BACKGROUND ART

Molding of polyurethane foam has been conducted by adopting the following procedure.

(1) An upper mold and a lower mold are kept open.

(2) A polyurethane foam molding material (liquid material) is fed into the lower mold side.

(3) The upper and lower molds are closed.

At this time, the polyurethane foam molding material generates CO₂ gas through a chemical reaction, and grows in the mold (undergoes free foaming and increases in volume). Simultaneously, the CO₂ gas generated is discharged to the exterior of the mold through a vent hole and the parting line.

(4) After the resin reaction has finished, the molded product is taken out of the mold, and flashes are removed from the molded product.

(5) The polyurethane foam left in the vent hole and in the parting line of the mold is removed by cleaning, and the above procedure is repeated.

In this case, the growth of polyurethane foam and the exhaust of gas to the exterior of the mold are in close relationship, and the above procedure relies on the condition of deflashing, so that dispersion of gas exhaust (namely, the growth of polyurethane foam) is generated. In addition, the gas exhaust is spontaneously stopped by curing of the resin itself, but the stoppage may be retarded due to dispersions of the mass of the gas left and the resin strength (depending on mold temperature and liquid temperature), resulting in the generation of “void”, a defect as if the surface of the foam is torn off.

### DISCLOSURE OF THE INVENTION

The present invention has been made in consideration of the above situations. Accordingly, it is an object of the present invention to provide a method of producing a foamed synthetic resin molding article in which molding of a foamed synthetic resin molding article having an open cell structure such as a flexible polyurethane foam or a closed cell structure can be achieved while suppressing the generation of flash and void, adhesion of material after molding can be reduced, and cleaning of the mold can easily be conducted.

The present inventors have made intensive and extensive studies in order to attain the above object. As a result, it has been found that a mold shut-off molding method in polyurethane foam molding comprising the steps of supplying a foamable material into a mold, closing all the vent holes of the mold communicating with the exterior at an arbitrary timing, stopping and fixing the growth of the foam by utilizing the rise in pressure of the foaming gas enclosed in the mold, and curing the foam in the growth-stopped condition is effective for obtaining a voidless and flashless product, and generation of flashes can be restrained by closing all the vent holes of the mold immediately before formation of flashes. Based on the findings, the present invention has been completed.

Accordingly, the present invention provides the following methods of producing a foamed synthetic resin molding article.

(1) A method of producing a foamed synthetic resin molding article by using a mold comprising a lower mold, an upper mold detachably disposed so as to cover an opening portion of the lower mold and form a closed space with the lower mold, and a cavity which is the closed space formed by the lower mold and the upper mold and into which a material for foamed synthetic resin molding article is supplied, supplying the material for foamed synthetic resin molding article into the cavity, closing the upper and lower molds, foaming the material for foamed synthetic resin molding article, curing the foamed body, and demolding the foamed and cured body, wherein the method comprises the steps of supplying the material for foamed synthetic resin molding article into the cavity under atmospheric pressure, closing the upper and lower molds so that a gas in the mold can be exhausted, conducting foam molding, preliminarily measuring a cavity fill-up time required for a foamed body of the material to fill up the cavity, supplying the material into the cavity under atmospheric pressure, closing the upper and lower molds so that the gas in the mold can be exhausted, causing foaming to proceed, and perfectly closing the upper and lower molds when the cavity fill-up time has passed.

(2) A method of producing a foamed synthetic resin molding article as set forth in (1) above, wherein a mold comprising a core mold detachably disposed in the closed space, a low-capacity cavity formed by an upper surface of the core mold and a lower surface of the upper mold when the core mold is disposed, and a high-capacity cavity formed by a lower surface of the core mold and an upper surface of the lower mold when the core mold is disposed, the high-capacity cavity communicated with the low-capacity cavity through a gap, and the mold thus having the low-capacity cavity and the high-capacity cavity as cavity, is used, and the method comprises the steps of supplying the material for foamed synthetic resin molding article into the high-capacity cavity under atmospheric pressure, closing the mold so that a gas in the mold can be exhausted on the side of the low-capacity cavity, causing foaming to proceed, and perfectly closing the upper and lower molds when the cavity fill-up time has passed.

(3) A method of producing a foamed synthetic resin molding article by using a mold comprising a lower mold, an upper mold detachably disposed so as to cover an opening portion of the lower mold and form a closed space with the lower mold, and a cavity which is the closed space formed by the lower mold and the upper mold and into which a material for foamed synthetic resin molding article is supplied, supplying the material for foamed synthetic resin molding article into the cavity, closing the upper and lower molds, foaming the material for foamed synthetic resin molding article, curing the foamed body, and demolding the foamed and cured body, wherein the upper mold is provided with a through-hole at a predetermined position, the through-hole is filled with a transparent resin, a fiber sensor is fitted at the transparent resin-filled portion, and the method comprises the steps of supplying the material for foamed synthetic resin molding article into the cavity under atmospheric pressure, closing the upper and lower molds so that a gas in the mold can be exhausted, causing foaming to proceed, and perfectly closing the upper and lower molds when filling-up of the cavity with the foamed body of the material is detected by the fiber sensor.

(4) A method of producing a foamed synthetic resin molding article as set forth in (3) above, wherein a mold comprising a core mold detachably disposed in the closed space, a low-capacity cavity formed by an upper surface of the core mold and a lower surface of the upper mold when the core mold is disposed, and a high-capacity cavity formed by a lower surface of the core mold and an upper surface of the lower mold when the core mold is disposed, the high-capacity cavity communicated with the low-capacity cavity through a gap, and the mold thus having the low-capacity cavity and the high-capacity cavity as cavity, is used, and the method comprises the steps of supplying the material for foamed synthetic resin molding article into the high-capacity cavity under atmospheric pressure, closing the mold so that a gas in the mold can be exhausted on the side of the low-capacity cavity, causing foaming to proceed, and perfectly closing the upper and lower molds when filling-up with the foamed body is detected by the fiber sensor.

(5) A method of producing a foamed synthetic resin molding article as set forth in any one of (1) to (4) above, wherein the foamed synthetic resin molding article is a flexible polyurethane foam molding article.

The methods according to the present invention as above ensure that molding of a foamed synthetic resin molding article having an open cell structure such as flexible polyurethane foam or a closed cell structure can be achieved while suppressing the generation of flashes and void defects, and cleaning of the mold can easily be conducted.

### BRIEF DESCRIPTION OF THE DRAWINGS

FIG. 1 is a sectional view of a mold for a front seat for vehicle using a polyurethane foam as foamed synthetic resin molding article according to one embodiment of the present invention;

FIG. 2 is a sectional view of a mold similar to FIG. 1 according to another embodiment of the present invention; and

FIG. 3 illustrates the structure of a fiber sensor, in which (a) is a front view of the fiber sensor, and (b) is a partly omitted side view of the same.

### BEST MODE FOR CARRYING OUT THE INVENTION

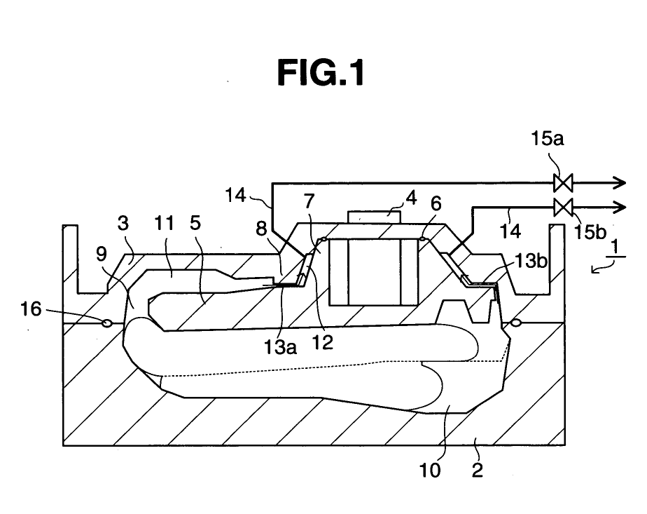

The present invention will be described in detail below referring to the drawings. The method of producing a foamed synthetic resin molding article according to the present invention can be carried out, for example, by using a mold 1 shown in FIG. 1.

FIG. 1 shows a sectional view of the mold 1 for a front seat for vehicle. The mold 1 for the front seat for vehicle comprises a lower mold 2, an upper mold 3 detachably jointed to the lower mold 2, and a core mold 5 fitted to the upper mold 3 so that it can be moved vertically by operation of a cylinder 4.

An upper surface of the core mold 5 is provided with a projected partition wall 7 fitted on its upper surface with a seal member 6 for surrounding the cylinder 4, and a lower surface of the upper mold 3 is provided with a demarcation projection 8 at an intermediate position between one tip end portion of the core mold 5 and the partition wall 7.

When the lower mold 2 and the upper mold 3 are jointed, the cylinder 4 is operated to advance the core mold 5 toward the upper mold 3, and the seal member 6 on the upper surface of the partition wall 7 is brought into close contact with the lower surface of the upper mold 3, a gap 9 is formed between one side wall of the lower mold 2 and a tip end portion on one side of the core mold 5, a high-capacity cavity 10 is formed between the upper surface of the lower mold 2 and the lower surface of the core mold 5, a low-capacity cavity 11 communicated to the high-capacity cavity 10 through the gap 9 in the condition of being bent by about 180° relative to the high-capacity cavity 10 is formed by the lower surface of the upper mold 3, the upper surface on one tip end side of the core mold 5 and the demarcation projection 8, and an exhaust space 12 is formed between the demarcation projection 8 and the partition wall 7. A minute gap 13a is formed between the projection 8 and the upper surface of the core mold 5, and the low-capacity cavity 11 and the exhaust space 12 are communicated to each other through the minute gap 13a. A minute gap 13b for communication between the high-capacity cavity 10 and the exhaust space 12 is formed between the upper surface on the other tip end side of the core mold 5 and the lower surface of the upper mold 3. The shapes and locations of the minute gaps 13a and 13b are not specifically limited, and can be appropriately determined according to the shape of the mold.

The upper mold 3 is provided with vent pipes 14 at positions where the exhaust space 12 is formed, and valves 15a and 15b are intermediately provided in the vent pipes 14. A seal member 16 is intermediately provided at a joint portion of the lower mold 2 and the upper mold 3; therefore, with the valves 15a and 15b opened, a gas in the cavities 10 and 11 can be discharged through the minute gaps 13a and 13b, the exhaust space 12 and the vent pipes 14, and, when the valves 15a and 15b are closed, the inside of the mold 1 is perfectly closed.

Of the front seat for vehicle formed by the high-capacity and low-capacity cavities 10 and 11, a seat main body to be located on the actual face side is formed by the high-capacity cavity 10, and a fitting portion required for fitting the seat on the back side is formed by the low-capacity cavity 11. The low-capacity cavity 11, for forming the fitting portion of the seat, is desired to be as low as possible in capacity from the viewpoint of material cost reduction, but if it is too low in capacity, defects would be easily generated in the fitting portion of the seat molded.

The high-capacity cavity 10 and the low-capacity cavity 11 are connected to each other through the gap 9, which ordinarily has a width of about 2 to 20 mm.

The mold 1 used for the method according to the present invention is so constructed as to be hermetically closed at a predetermined timing, and the inside and the outside of the mold 1 can be perfectly shut off and closed by closing the valves 15a and 15b after mold clamping.

The expression “perfectly closed” herein means such a closed condition that not any ventilation is permitted even through minute gaps at the parting line as well as vent holes; in the example shown in FIG. 1, the seal member 16 is disposed at a predetermined position of the parting line of the mold, whereby ventilation through the parting line is shut off and the mold is perfectly closed.

In the present invention, in producing a foamed synthetic resin molding article, particularly a flexible polyurethane foam molding article, prior to the start of actual production of the article, a polyurethane foam molding material (liquid material) to be used in the production of the article is fed into the cavity (the high-capacity cavity 10 and the low-capacity cavity 11) of the mold to be used in the production of the article, foaming is caused under atmospheric pressure, and, in the condition where the gas in the cavity can be exhausted even after mold clamping, the time required for the polyurethane foam in the cavity to penetrate into the minute gaps 13a and 13b and the time required for the polyurethane foam to perfectly fill up the cavity are measured.

The measurement is conducted as follows. When all the vent holes of the mold are shut off or pressurization is conducted at an arbitrary time point from the mold clamping to the fill-up, the growth of the foam is stopped at the time point, and the foam is cured in that condition; therefore, when the molded article is obtained by demolding, various features such as fluidity of the molding material in the mold and the reaching position in the mold at that time point can be evaluated. Accordingly, a method may be preferably adopted in which the polyurethane foam molding material is fed into the mold (into the high-capacity cavity 10 in the mold shown in FIG. 1), thereafter all the vent holes are perfectly closed after the lapse of various time periods to obtain various foam samples, from which a foam sample free of such defects as air stagnation and substantially free of formation of flashes is selected, and the time period from the feeding of the polyurethane foam molding material or from the ventilatable mold clamping to the closing of the vent holes (to the perfect closing of the mold) in the case of obtaining the foam sample is evaluated as cavity fill-up time. Namely, a method is recommended in which the procedure of supplying the polyurethane foam molding material to a predetermined position in the mold, clamping the mold, thereafter perfectly closing the mold or pressurizing to thereby stop the reaction of the polyurethane foam, and demolding the molded article is repeated at different lapses of time with the same material, and the molded articles obtained are compared with each other to measure the fill-up time for each portion in the cavity.

According to the present invention, after the cavity fill-up time is obtained as described above, a polyurethane foam molding material is fed into the high-capacity cavity of the mold, mold clamping is conducted in the ventilatable condition (in the condition where the valves 15a and 15b are opened), and the valves 15a and 15b communicating with the filled-up portion are independently closed at the time when the fill-up time for each portion in the cavity is reached (the time point immediately before the penetration of the polyurethane foam into the minute gaps 13a and 13b), whereby the mold is perfectly closed. By this, the material in the cavity does not undergo further foaming, and is cured in that foamed condition, so that formation of flashes is restrained, and a favorable molded article substantially the same as the foam sample selected in the measurement of the cavity fill-up time can be obtained.

In place of the preliminary measurement of the cavity fill-up time as described above, a method may be adopted in which the upper mold is provided with a through-hole at a predetermined position, the through-hole is filled with a transparent resin, a fiber sensor is fitted to the portion filled with the transparent resin, the material for foamed synthetic resin molding article is fed into the cavity under atmospheric pressure, the upper and lower molds are clamped in such a condition that the gas in the mold can be exhausted, foaming is caused to proceed, and the upper and lower molds are perfectly closed when the fill-up of the cavity with the foamed body of the material is detected by the fiber sensor.

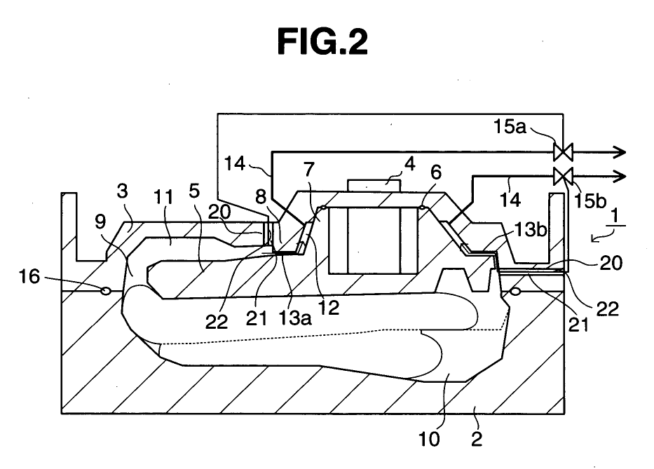

More in concrete, as shown in FIG. 2, a method can be adopted in which the upper mold 3 is provided with through-holes 20 at predetermined positions, preferably in the vicinity of the minute gaps 13a and 13b, the through-holes 20 are filled with a transparent resin 21, fiber sensors 22 are fitted to the portions filled with the resin 21 so as to detect the condition where the foamed body of the material for foamed synthetic resin molding article fills up the cavity (low-capacity cavity 11) and is about to flow into the minute gaps 13a and 13b, and the valves 15a and 15b are closed by supplying the valves 15a and 15b with a closing command signal from the fiber sensor 22 when the fill-up of the cavity with the foamed body of the material is detected by the fiber sensor 22. By this, the fill-up times for each portion can be obtained by a single stroke of molding, and, by detecting the fill-up condition by the fiber sensor, the timing for closing the inside of the mold can be automatically adjusted even where the fill-up time of the polyurethane foam is dispersed in the actual production. The fitting position of the fiber sensor is not specifically limited, and can be determined appropriately according to the shape of the mold. As the fitting position, for example, a final reaching position of the material or the position where defects of molding are liable to occur can be selected. The fiber sensors can be fitted not only to the upper mold but also to the lower mold and the core mold at required positions, as required.

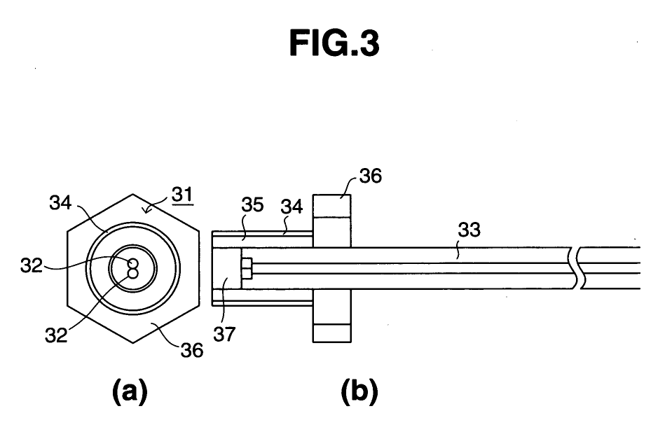

Now, the structure of the fiber sensor will be described referring to FIG. 3, which shows a front view (a) and a partially omitted side view (b) of the fiber sensor 31.

The fiber sensor 31 comprises an optical fiber cable 33 having two optical fibers 32, 32, in which light is emitted through one of the optical fibers, and reflected light is received through the other of the optical fibers. The tip end side of the optical fiber cable 33 is covered with a polycarbonate-made protective cover 35 provided with a screw portion 34 at its outside periphery. Numeral 36 denotes a fitting screw portion.

The fiber sensor 31 can pick up ON/OFF signals, and can undergo automatic control. Specific examples of the fiber sensor include a Keyence digital laser sensor (non-contact sensor) and the like.

The fitting is conducted by providing the mold with a through-hole (threaded hole), filling the tip end side of the through-hole with a transparent resin, and fitting the fiber sensor by screwing into the hole. It is preferable that, as shown in FIG. 3, a void 37 in a tip end portion of the protective cover 35 projected forwards than the tip end of the cable 33 is filled with a transparent resin, and, in this condition, the fiber sensor is fitted by screwing into the hole.

### EXAMPLE

An example is given below to describe the present invention in concrete, but the present invention is not limited to the following example.

Foam molding was conducted by using a mold shown in FIG. 1 and a foamable liquid material for flexible polyurethane foam (Everlight D, a product by Bridgestone Corp.). In the mold, the gap between the lower mold 2 and the core mold 5 in FIG. 1 is about 60 mm, the gap between the upper mold 3 and the core mold 5 is about 15 mm, and the gap 9 is about 10 mm.

First, the foamable liquid material was fed into the mold, and, immediately, mold clamping was conducted in the condition where the valves 15a and 15b are opened. Thereafter, the valves 15a and 15b were simultaneously closed at the time when a preset period of time has passed from the start of feeding, whereby the inside of the mold was perfectly closed. The appearance of the foam samples thus obtained were evaluated, and it was recognized that the condition for obtaining a foam sample free of flashes and voids is to close the valve 15a after the lapse of 29 sec from the start of feeding and to close the valve 15b after the lapse of 35 sec from the start of feeding.

Next, the foamable liquid material was fed into the mold in the same manner as above, mold clamping was conducted, foaming was caused, and, at the time when the fill-up time for each portion has passed, the valves 15a and 15b were independently closed, thereby perfectly closing the inside of the mold. After the lapse of 360 sec, the molded article was taken out of the mold, whereby a favorable molded article free of voids and flashes could be obtained.

### INDUSTRIAL APPLICABILITY

The method according to the present invention can preferably be used for production of a front seat for vehicle. Particularly, the method is preferable in the case of using a mold comprising a core mold for molding a complicate-shaped molded article. The method is preferable for molding a flexible polyurethane foam article.

1. A method of producing a foamed synthetic resin molding article by using a mold comprising a lower mold, an upper mold detachably disposed so as to cover an opening portion of said lower mold and form a closed space with said lower mold, and a cavity which is said closed space formed by said lower mold and said upper mold and into which a material for foamed synthetic resin molding article is supplied, supplying said material for foamed synthetic resin molding article into said cavity, closing said upper and lower molds, foaming said material for foamed synthetic resin molding article, curing the foamed body, and demolding the foamed and cured body, wherein said method comprises the steps of supplying said material for foamed synthetic resin molding article into said cavity under atmospheric pressure, closing said upper and lower molds so that a gas in said mold can be exhausted, conducting foam molding, preliminarily measuring a cavity fill-up time required for a foamed body of said material to fill up said cavity, supplying said material into said cavity under atmospheric pressure, closing said upper and lower molds so that the gas in said mold can be exhausted, causing foaming to proceed, and perfectly closing said upper and lower molds when said cavity fill-up time has passed.

2. A method of producing a foamed synthetic resin molding article as set forth in claim 1, wherein a mold comprising a core mold detachably disposed in said closed space, a low-capacity cavity formed by an upper surface of said core mold and a lower surface of said upper mold when said core mold is disposed, and a high-capacity cavity formed by a lower surface of said core mold and an upper surface of said lower mold when said core mold is disposed, said high-capacity cavity communicated with said low-capacity cavity through a gap, and said mold thus having said low-capacity cavity and said high-capacity cavity as cavity, is used, and said method comprises the steps of supplying said material for foamed synthetic resin molding article into said high-capacity cavity under atmospheric pressure, closing said mold so that a gas in said mold can be exhausted on the side of said low-capacity cavity, causing foaming to proceed, and perfectly closing said upper and lower molds when said cavity fill-up time has passed.

3. A method of producing a foamed synthetic resin molding article by using a mold comprising a lower mold, an upper mold detachably disposed so as to cover an opening portion of said lower mold and form a closed space with said lower mold, and a cavity which is said closed space formed by said lower mold and said upper mold and into which a material for foamed synthetic resin molding article is supplied, supplying said material for foamed synthetic resin molding article into said cavity, closing said upper and lower molds, foaming said material for foamed synthetic resin molding article, curing the foamed body, and demolding the foamed and cured body, wherein said upper mold is provided with a through-hole at a predetermined position, said through-hole is filled with a transparent resin, a fiber sensor is fitted at the transparent resin-filled portion, and said method comprises the steps of supplying said material for foamed synthetic resin molding article into said cavity under atmospheric pressure, closing said upper and lower molds so that a gas in said mold can be exhausted, causing foaming to proceed, and perfectly closing said upper and lower molds when filling-up of said cavity with the foamed body of said material is detected by said fiber sensor.

4. A method of producing a foamed synthetic resin molding article as set forth in claim 3, wherein a mold comprising a core mold detachably disposed in said closed space, a low-capacity cavity formed by an upper surface of said core mold and a lower surface of said upper mold when said core mold is disposed, and a high-capacity cavity formed by a lower surface of said core mold and an upper surface of said lower mold when said core mold is disposed, said high-capacity cavity communicated with said low-capacity cavity through a gap, and said mold thus having said low-capacity cavity and said high-capacity cavity as cavity, is used, and said method comprises the steps of supplying said material for foamed synthetic resin molding article into said high-capacity cavity under atmospheric pressure, closing said mold so that a gas in said mold can be exhausted on the side of said low-capacity cavity, causing foaming to proceed, and perfectly closing said upper and lower molds when filling-up with said foamed body is detected by said fiber sensor.

5. A method of producing a foamed synthetic resin molding article as set forth in claim 1, wherein said foamed synthetic resin molding article is a flexible polyurethane foam molding article.
